(19) United States
(12) Patent Application Publication
(10) Pub. No.: US 2025/0259280 A1
(43) Pub. Date: Aug. 14, 2025

(54) IMAGE PROCESSING

(71) Applicant: Arm Limited, Cambridge (GB)

(72) Inventors: Daniel Larkin, West Bridgford (GB); David Hanwell, Sale (GB)

(73) Assignee: Arm Limited, Cambridge (GB)

(21) Appl. No.: 19/048,064

(22) Filed: Feb. 7, 2025

(30) Foreign Application Priority Data
Feb. 14, 2024 (GB) 2402056.2

(51) Int. Cl. G06T 5/70; G06T 5/20

(52) U.S. Cl. CPC G06T 5/70; G06T 5/20

(57) ABSTRACT

A method and apparatus for processing image data is provided. The method comprises receiving decompressed accumulated image data that has been subjected to a lossy compression algorithm. The accumulated image data includes an accumulated frame of image data and a corresponding plurality of blending coefficients. The blending coefficients are updated by identifying an image feature associated with at least one pixel location of the accumulated frame of image data. The updated blending coefficients and decompressed accumulated frame of image data are sent to a temporal noise reducer, which is configured to use the updated blending coefficients to combine the decompressed accumulated frame of image data with a newly received frame of image data to generate an output image.

### CROSS REFERENCE TO RELATED APPLICATION

This application claims the benefit under 35 U.S.C. § 119(a) and 37 CFR § 1.55 to UK patent application no. 2402056.2, filed on Feb. 14, 2024, the entire content of which is incorporated herein by reference.

### TECHNICAL FIELD

The present invention relates to methods and apparatus for processing image data. More specifically, the present disclosure relates to temporal de-noising of image data.

### BACKGROUND

Image sensors for capturing images may be present in devices such as digital cameras, mobile phone cameras, and other image capturing devices. Image sensors used to capture images may comprise millions of individual sensor elements for determining an intensity of light arriving on the sensor at each sensor element. Each sensor element represents a pixel. The light intensity information gathered by these sensors may be used to recreate an image captured by the sensor. Light intensity information gathered by these sensors may be susceptible to signal noise which may introduce errors in the light intensity information. Noise may be introduced into light intensity information from several sources such as Shot noise, Dark current noise, and Read noise. It is desirable to reduce the impact of noise.

### SUMMARY

According to a first aspect of the present invention, there is provided a method of processing image data comprising: receiving decompressed accumulated image data that has been subjected to a lossy compression algorithm, the accumulated image data including: an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data; updating the blending coefficients of the decompressed accumulated image data by identifying an image feature associated with at least one pixel location of the decompressed accumulated frame of image data, and modifying at least one blending coefficient of the accumulated image metadata corresponding to the at least one pixel location based on the image feature; and sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

According to a second aspect of the present invention, there is provided image processing apparatus comprising at least one processor and at least one storage. The apparatus is configured to perform a method comprising at least: receiving decompressed accumulated image data that has been subjected to a lossy compression algorithm, the accumulated image data including: an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data; updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and sending the updated blending coefficients and the decompressed accumulated frame of image data to the temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

The image processing apparatus may comprise one or more hardware units. The one or more hardware units may include circuitry such as one or more application specific integrated circuits, one or more processors, one or more field programmable gate array, a storage unit or the like. The circuitry may include a storage unit and/or input/output interfaces for communicating with external devices.

According to a third aspect of the present invention, there is provided a non-transitory computer-readable storage medium comprising computer-executable instructions which when executed by a processor cause operation of an image processing system to perform a method comprising at least: receiving decompressed accumulated image data that has been subjected to a lossy compression algorithm, the accumulated image data including: an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data; updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

Features described in the context of one aspect of the invention are equally applicable to the other aspects, where appropriate. Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates schematically an example of an image signal processing system as background to the present disclosure;

FIGS. 2 and 3 illustrate schematically processes performed by the image processing system of FIG. 1 as background to the present disclosure;

FIG. 4 shows a flowchart of an image processing method according to an example of the present disclosure;

FIG. 5 illustrates schematically examples of steps of the method of FIG. 4;

FIG. 6 illustrates schematically an example of an image signal processing system according to an example of the present disclosure;

### DETAILED DESCRIPTION

Methods and apparatus for performing image processing will be described below.

### Example Embodiments

A first embodiment provides a method of processing image data comprising: receiving decompressed accumulated image data that has been subjected to a lossy compression algorithm, the accumulated image data including an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data; updating the blending coefficients of the decompressed accumulated image data by identifying an image feature associated with at least one pixel location of the decompressed accumulated frame of image data, and modifying at least one blending coefficient of the accumulated image metadata corresponding to the at least one pixel location based on the image feature; and sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

In some embodiments, the at least one blending coefficient is modified such that in generating the output image data by the temporal noise reducer, a contribution of the new frame of image data is increased.

In some embodiments, the modification of the blending coefficient is performed by comparing the blending coefficient to a threshold value.

In some embodiments, the image feature corresponds to an area of the accumulated frame of image data having higher spatial frequency information than another part of the accumulated frame of image data.

In some embodiments, the image feature is at least partially identified by performing a high-pass filtering on at least a portion of the accumulated frame of image data.

In some embodiments, the image feature is at least partially identified by performing edge detection on at least a portion of the accumulated frame of image data.

In some embodiments, the image feature is at least partially identified by performing facial recognition on at least a portion of the accumulated frame of image data.

In some embodiments, the image feature is at least partially identified by detecting a characteristic feature of the lossy compression process.

In some embodiments, the blending coefficient is modified such that in generating the output image data by the temporal noise reducer, a contribution of the new frame of image data is decreased.

In some embodiments, the image feature corresponds to an area of lower spatial frequency information than another part of the accumulated frame of image data.

In some embodiments, the image feature is at least partially identified by identifying a luminance of the accumulated image data.

In some embodiments, each blending coefficient of the accumulated image metadata is a number of frames of previous image data used to generate the pixel intensity value at the corresponding pixel location, and each pixel intensity value of the accumulated frame of image data is an arithmetic mean of the corresponding pixel intensity values of the number of frames of previous image data indicated by the blending coefficient.

In some embodiments, the method further comprises generating the output image data by the temporal noise reducer.

In some embodiments, the method further comprises updating the accumulated image data based on the output image data.

In some embodiments, the method further comprises receiving the accumulated image data from the temporal noise reducer.

In some embodiments, the method further comprises sending the accumulated image data to a compressor for compressing by a lossy compression process.

In some embodiments, the method further comprises storing the compressed accumulated image data.

A second embodiment comprises an image processing apparatus comprising at least one processor, and at least one storage. The apparatus is configured to perform a method comprising at least: receiving decompressed accumulated image data that has been subjected to a lossy compression algorithm, the accumulated image data including an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data; updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

A third embodiment comprises a non-transitory computer-readable storage medium comprising computer-executable instructions which when executed by a processor cause operation of an imaging processing system to perform a method comprising at least: receiving decompressed accumulated image data that has been subjected to a lossy compression algorithm, the accumulated image data including an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data; updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and sending the updated blending coefficients and the decompressed accumulated frame of image data to the temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

### Image Processing System and Method

Some image processing techniques to address noise include capturing a plurality of successive frames of previous image data of the same scene and averaging them together to reduce the noise in the resulting image. This is known as temporal noise reduction. Image data representing a cumulative average image is output while further frames of image data are captured and averaged. As the number of frames representing the same scene increases, the noise in the averaged image generally reduces.

However, performing temporal noise reduction can require accumulated image data, representing the cumulative average image, to be repeatedly stored in and retrieved from storage in order to process each further frame of image data once captured. To reduce the memory bandwidth and/or storage space required to perform temporal noise reduction, compression algorithms can be used to reduce the size of stored image data. In particular, lossy compression algorithms can offer the largest reduction in size. A downside of lossy compression algorithms is that artefacts can be introduced into the data being compressed.

Accordingly, there is a trade-off to be made between temporal de-noising and the introduction of compression artefacts into an image processed using temporal noise reduction. On the one hand, temporal denoising tends to work more effectively with a larger number of accumulated image frames contributing to an average image to reduce the presence of noise, which can improve image quality. On the other hand, repeatedly compressing and decompressing the accumulated image frames in order to obtain this larger number of contributing previous frames can increase the occurrence of compression artefacts, which can reduce image quality. It is desirable to improve image quality whilst performing temporal denoising.

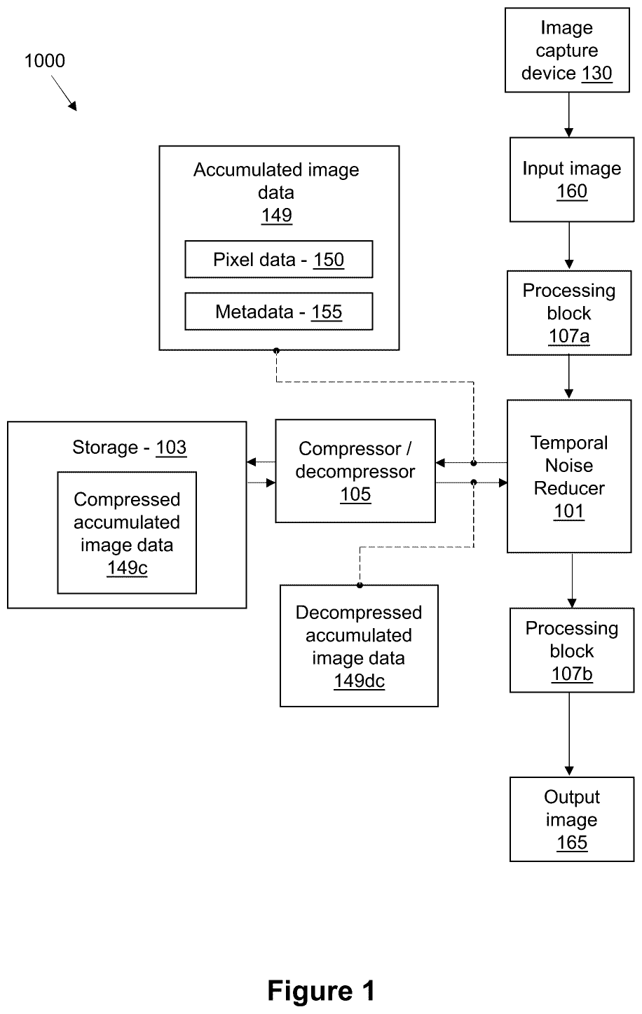

FIG. 1 shows an example of an image signal processing system 1000. As an overview, the image signal processing system 1000 is for receiving an input image 160, in this case from an image capture device 130, and performing temporal noise reduction by a temporal noise reducer 101 on the input image 160 to generate an output image 165 in which visible noise has been reduced compared with the input image 160.

To perform this function, the image signal processing system 1000 comprises a temporal noise reducer 101 in communication with a storage 103. A data compressor and decompressor 105 is provided to compress data from the temporal noise reducer 101 prior to storage in the storage 103, and to decompress data when retrieved from the storage 103. Processing blocks 107a, 107b are illustrated here to represent the existence of pre- and post-processing functions of the image processing system 1000 which may occur before or after temporal noise reduction by the temporal noise reducer 101. The processing blocks 107a, 107b may perform functions such as data cleaning or data normalisation, for example, or formatting such as converting from Bayer to RGB colour data, for example.

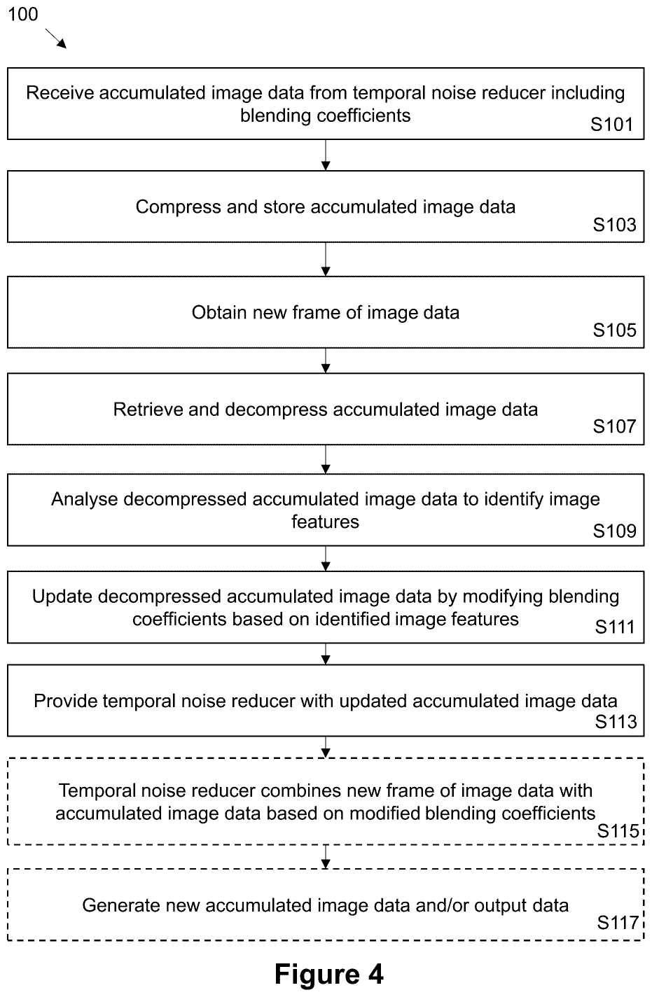

A method 100, described later and set out by FIGS. 4-6, can be implemented by the image signal processing system 1000 to improve the quality of output images 165.

The image processing system 1000 handles image data received from an image capture device 130. Image data may originate from an image sensor comprising an array of sensor elements also referred to as sensor pixels. The array of sensor pixels generates an array of pixel data, also referred to herein as a frame of image data, comprising a plurality of pixel intensity values at respective pixel locations, each corresponding to an amount of light received by a respective sensor element. For example, each pixel intensity value may represent a luminance of captured light, which is for example a measure of the intensity of light per unit area rather than absolute intensity. In other examples, the pixel intensity values are representative of a brightness of captured light corresponding to a perception of luminance, which may or may not be proportional to luminance. The frames of image data may be generated and/or stored in any suitable format, for example as a Bayer pattern image.

Image data generated from an image sensor is susceptible to noise of a variety of types. Noise is the degree to which a pixel intensity value differs from a “true” value. Noise can arise through a number of different sources. For example, it can arise as shot noise through the number of photons detected by a photosensor, caused by statistical quantum fluctuations, wherein the shot noise at each sensor pixel is independent of the shot noise at other sensor pixels. Shot noise may have a Poisson distribution. Noise can also arise as dark current noise, arising from relatively small electric currents which flow through photosensors such as charge-coupled device even when there is no incident radiation being captured by the photosensor. Dark current noise is independent of the photon count and may be related to the temperature of the photosensor. Dark current noise may have a Normal distribution. Read noise is another sources of noise, related to the analogue gain used by the image sensor and may have a Normal distribution. The noise on image data varies temporally in that, for a plurality of images representing a same scene, each pixel intensity value can vary from some underlying “true” value by different amounts between the different images.

To address the issue of noise, the temporal noise reducer 101 uses accumulated image data 149 in combination with a newly received frame of image data 160. The accumulated image data 149 includes an averaged frame of data representing a plurality of frames of previously acquired image data. The temporal noise reducer 101 blends the newly received frame of data 160 with the accumulated image data 149 to reduce noise in a resulting output image 165.

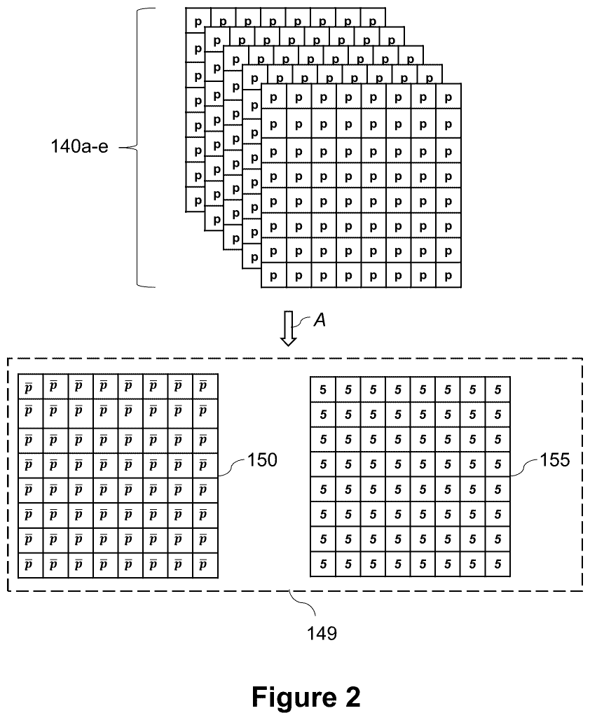

FIG. 2 illustrates schematically an example of accumulated image data 149 generated by the temporal noise reducer 101. The accumulated image data 149 includes an accumulated frame of image data 150 as well as metadata comprising a plurality of blending coefficients 155.

To form the accumulated frame of image data 150, a plurality of frames of previously acquired image data 140a-e are combined via in averaging process A such that, at each pixel location, the pixel intensity value p of each previously acquired image frame 140a-e are averaged to form an accumulated frame of image data 150 having averaged pixel intensity values p̅. Whilst in the simplified depiction of FIG. 2 a value “p” is indicated at each pixel location of the previous image frame, and a value “p̅” is indicated at each pixel location of the accumulated frame of image data, it will be understood that the pixel intensity values p, p̅ generally vary across the image.

Accompanying the accumulated frame of image data 150 is metadata which is an array of blending coefficients 155. Each blending coefficient 155 is associated with a respective pixel location of the accumulated frame of image data 150. Generally, the blending coefficients 155 describe the number of frames of previous image data used by the averaging process A to form the pixel intensity value in the accumulated frame of image data 150. As with the pixel intensity values, the blending coefficients vary across the image as will be described in more detail below. In a simple example illustrated in FIG. 2, five frames of previous image data were averaged to determine the pixel intensity values at each pixel location of the accumulated frame of image data 150, so each blending coefficient 155 is assigned the value “5” (five). Whilst presented in a uniform manner in FIG. 2, generally the metadata may vary across the frame, for instance a first pixel location being formed from averaging 10 frames of previous image data, whilst a second pixel location is formed from averaging 5 frames of previous image data. When initially forming the accumulated frame of image data 150, there may be just a single frame of previous image data available, rather than a plurality as described above. In that instance, the accumulated frame of image data 150 may simply be formed of the single frame of previous image data, and the blending coefficient indicating that just a single frame of image data formed the accumulated image data, for example by being assigned the value “1”. In this case, the accumulated image data 149 can still be understood to represent an average of the previous frame of image data as the average is simply equivalent to the previous frame of image data.

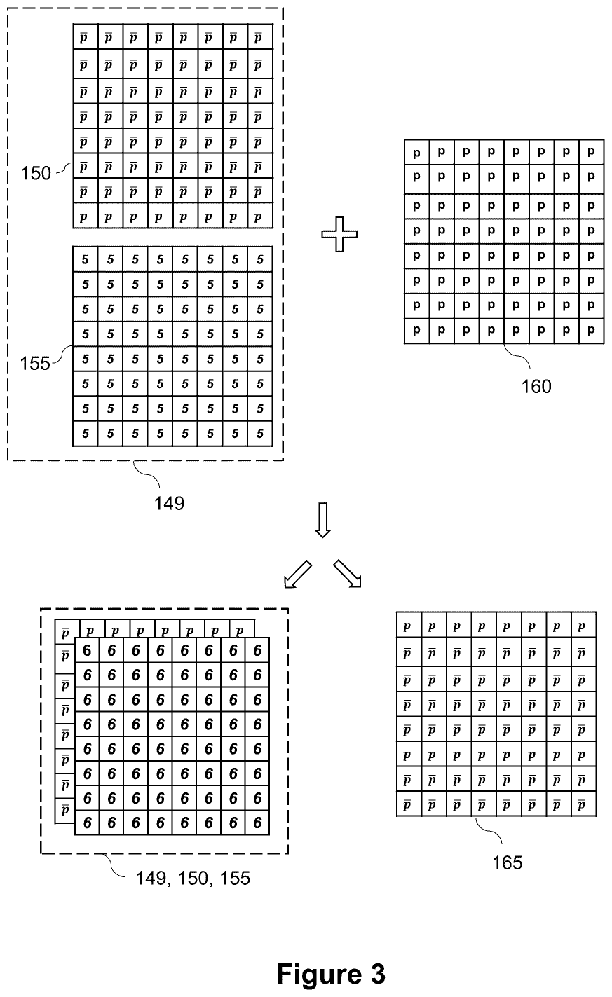

FIG. 3 illustrates schematically an example of how the temporal noise reducer uses the accumulated image data 149 in conjunction with a newly received frame of image data 160 to reduce noise in an output image 165. Generally, the accumulated frame of image data 150 and the newly received frame of image data 160 are blended together. The weighting, or, in other words, the relative contribution of each of the accumulated frame of image data 150 and the newly received frame of image data 160 is determined by the blending coefficients 155. In this example, the blending coefficient 155 is the number of frames of previous image data 140a-e which were averaged to form the accumulated frame of image data 150. Designating the number of frames forming the accumulated frame of image data 150 as N, the temporal noise reducer, in this example, blends the newly received frame of image data 160 in a ratio of 1:N. An output image 165 is therefore formed which is a weighted average of the accumulated frame of image data 150 and the newly received image data 160. The pixel intensity values of the output image are, in the explanatory example depicted by FIG. 3, accordingly formed of a weighted average comprising ⅚ parts accumulated image data and ⅙ parts newly received image data.

Accumulating a frame of image data by averaging successive frames of image data reduces the noise in the resultant output frame of image data. As the noise value at each pixel location is independent between successive frames, combining N frames of image data in the manner just described may reduce the noise in the accumulated frame by a factor of \sqrt{N} in comparison to the noise of each individual frame of image data. In this context, averaging may comprise calculating a mean value, although it will be appreciated that other types of averaging are also possible, such as calculating a normalized weighted mean in which the frames of image data are not weighted equally.

Additionally, the image formed by combining the accumulated frame of image data 150 and the newly received frame of image data 160 can be used as an updated accumulated frame of image data. The updated accumulated frame of image data represents an additional previous frame of image data relative to the previous accumulated frame of image data. In this way, the process depicted by FIG. 2 may not involve averaging a plurality of frames at once. Instead, for example, an iterative process which constructs the accumulated frame of image data 150 one frame at a time by repeatedly blending previous accumulated frames of image data with newly received frames could be used. The resulting accumulated frame of image data would nevertheless represent information from N frames of previous image data, even if constructed one frame at a time. The skilled person will appreciate that there are multiple ways of generating accumulated image data based on previous frames of image data, and it can vary between examples.

The example above illustrates a case in which each pixel intensity value in the accumulated frame is based on the preceding images (in the example, preceding five images) and the accumulation is performed with a ratio 1:N for each pixel. In addition to the general process of temporal noise reduction described above, further steps may be taken by the temporal noise reducer 101. For example, temporal noise reduction is more likely to have a beneficial effect if pixel intensity values represent a same subject in each captured image frame, since each pixel location should have a same or similar value in each frame to benefit from the effect of averaging. This will occur when captured images contain substantially the same image information. Motion-detection allows for regions of the image which are moving to be identified and the temporal noise reduction effect to be withheld to avoid artefact such as blurring or smearing of the image. An example of motion-detection performed as part of a temporal denoising algorithm is described in GB2583519. As the present invention does not concern motion compensation, further details are not provided here. However, the examples described herein are compatible with temporal noise reducers 101 that implement motion compensation functionality.

In performing temporal noise reduction for a plurality of successive input images, the accumulated image data 149 is repeatedly stored and retrieved from storage 103 as each new input image 160 is received. To reduce load on memory bandwidth and space occupied in the storage 103, a compressor 105 performs a lossy compression process on the accumulated image data 149 before the accumulated image data 149 is stored in the storage 103 as compressed accumulated image data 149c. It will be appreciated that lossy compression typically results in a greater compression (i.e. a larger reduction in storage size) than lossless compression. When the compressed accumulated image data 149c is retrieved from the storage 103 for use by the temporal noise reducer 101, the decompressor 105 must first decompress the accumulated image data 149 to acquire decompressed accumulated image data 149dc. The use of the lossy compression technique by the compressor 105 accordingly introduces a risk of compression artefacts in the decompressed accumulated image data 149dc. The compression artefacts may be found in both or either of the pixel data 150 and the blending coefficients forming the metadata 155.

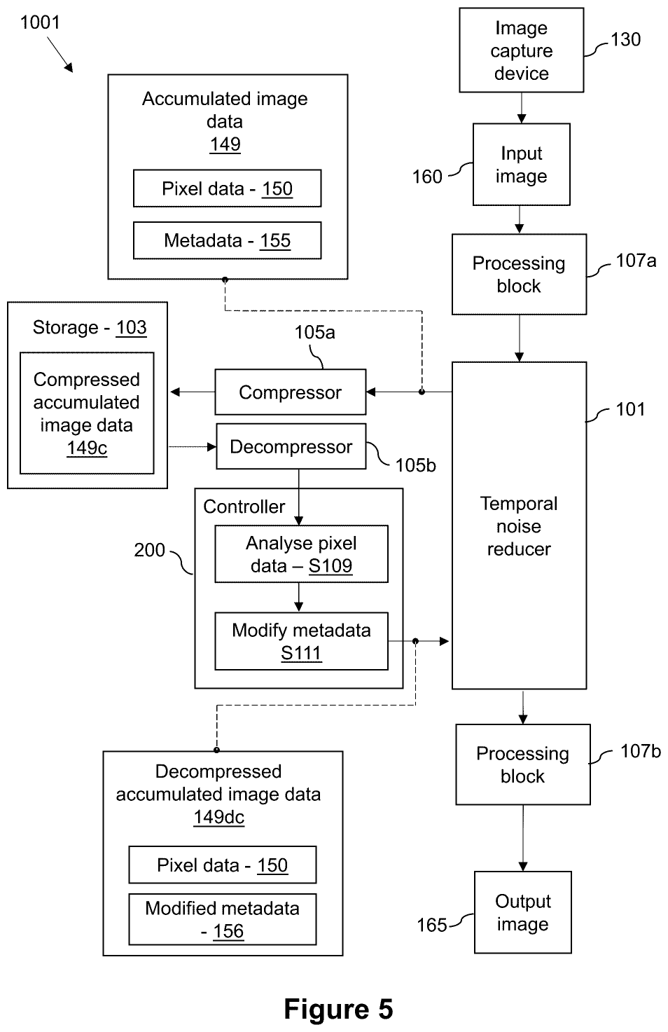

It will be appreciated that whilst noise in the output image 165 can be reduced by accumulating previous frames of image data, a risk of introducing compression artefacts in the image data can grow through repeated lossy compression, storage, retrieval, and decompression. FIG. 4 depicts a method 100 for image processing which implements temporal noise reduction which addresses this issue, whilst FIG. 5 illustrates an image processing system 1001 for performing the method 100.

At item S101, accumulated image data 149 is received from a temporal noise reducer 101. The accumulated image may have been generated from a plurality of frames of previous image data 140a-e. Each pixel value of the accumulated image may have been generated using an averaging process from one or more pixels of previous image frames. The accumulated image data 149 includes an accumulated frame of image data 150 and blending coefficients 155 which indicate a number of frames of previous image data 140a-e which contributed to each pixel of the accumulated frame of image data 155 as described above in connection with FIG. 2.

At item S103, the accumulated image data 149 is compressed by the compressor 105a and stored as compressed accumulated image data 149c in storage 103. The compression is lossy compression, which can permit a higher compression ratio and therefore smaller storage size and reduced load on memory bandwidth, for example, compared with lossless compression or not compressing data at all, for example. The compression method may utilise transform coding methods such as discrete cosine transform methods, for example, or colour quantisation or chroma subsampling methods, for example. The compression may involve compressing only the accumulated frame of image data 150, or may involve also compressing the blending coefficients 155 as well.

At item S105, a new frame of image data 160 is obtained, such as from image capture device 130. The new frame of image data 160 may be obtained directly from an image sensor of an imaging device, for example, or may be sent from another system, for example being retrieved from storage.

At item S107, the compressed accumulated image data 149c stored in storage 103 at item S103 is retrieved, and decompressed by the decompressor 105b into decompressed accumulated image data 149dc. As described previously, the decompressed accumulated image data 149dc may have artefacts introduced from the lossy compression and decompression steps.

At items S109 and S111, the decompressed accumulated image data 149dc is analysed and modified as described in the following paragraphs. In this example, this is performed by a controller 200, but it will be appreciated that the precise arrangement of the image processing system 1000, 1001 which performs these steps may vary between examples. In this example, these steps are performed by at least one processor of the image processor system 1000, 1001, and are not necessarily limited to a specific component, for example. As explained further below, in other examples, the controller could be implemented in fixed function hardware. The controller 200 can be added into an existing image processing system and items S109 and S111 performed by the controller 200 to improve an output image 165 of the image processing system, for example, without requiring direct modification, revalidation, or reverification of the image processing system, for example.

At item S109, the accumulated frame of image data 150 of the decompressed accumulated image 149dc is analysed in order to identify image features. Specific examples of image features, and techniques for detection thereof, are described shortly hereafter under Image feature identification. Whilst the analysis performed at item S109 can vary between examples, generally, at item S109 image features are identified which are either (a) more vulnerable to the impact of compression or (b) more resilient to the impact of compression. The identification of these image features allows for steps to be taken at item S111 to improve the image quality.

At item S111, the blending coefficients 155 of the decompressed accumulated image data 149c are modified based on the identified image features. Specific examples of how the blending coefficients 155 might be modified based on the image features are described shortly hereafter, under Modification of blending coefficients. Whilst the precise modifications to the blending coefficients 155 vary between examples, generally, at item S111 the blending coefficients 155 are modified such that either the contribution of a newly received frame of image data 160 is increased and the contribution of the accumulated frame of image data 150 is decreased when forming the output image, or such that the contribution of a newly received frame of image data 160 is decreased and the contribution of the accumulated frame of image data 150 is increased when forming the output image 165. Both modifications can occur concurrently, for example by increasing the blending coefficients 155 in one area of an image due to a first identified image feature, and decreasing the blending coefficients at a different area of an image due to a second identified image feature. Modifying the blending coefficients 155 can improve the quality of the output image 165. For example, modification of the blending coefficients 155 can allow, respectively, compression artefacts to be “overridden” by highly-weighted pixels from the newly received frame 160, which does not feature compression artefacts, or noise to be decreased by using highly-weighted pixels from the accumulated frame of image data 150 in regions which are resilient to compression artefacts.

It will be appreciated that due to modification at item S111, the blending coefficients 155 may cease to reflect the actual number of frames of previous image data which have been captured and contributed to forming the decompressed accumulated frame of image data 150. In examples, an unmodified historic set of blending coefficients may be maintained which continues to accurately map the actual number of frames of previous image data which have been captured and contribute to forming the decompressed accumulated frame of image data 150. This could be used to intermittently update the modified blending coefficients, for example, or as part of the analysis at item S109 and modifications at item S111.

At item S113, the temporal noise reducer 101 is provided with the updated decompressed accumulated image data 149dc, in which the blending coefficients have been modified at item S111 compared with the accumulated image data 149 originally output by the temporal noise reducer 101 at item S101.

Items S115 and S117 represent steps performed by the temporal noise reducer 101 upon receipt of the updated decompressed accumulated image data 149dc, and are included in the description of the method 100 to provide context for the effect of the previous steps. The methods described herein may be implemented with a wide range of temporal noise reducers that accept accumulated image data in a form comprising pixel values and blending coefficients as described with respect to FIG. 2. As noted above in connection with motion compensation, temporal denoisers may apply a variety of methods to generate a new accumulated image based on the pixel values and blending coefficients. Accordingly, the methods of adjusting the blending coefficients described herein are useful regardless of the details of the method performed by the temporal denoiser.

At item S115, the temporal noise reducer 101 combines a newly received frame of image data 160 with the updated, decompressed accumulated image data 149dc having modified blending coefficients 155.

At item S117, the temporal noise reducer generates new accumulated image data and/or output data based on the combination of the newly received frame of image data with the updated, decompressed accumulated image data 149dc.

As described previously, the updated blending coefficients mean that in some areas of the output image 165 the newly received frame of image data 160 may relatively overcontribute compared to the decompressed accumulated frame of image data 150, whereas in other areas of the image the newly received frame of image data 160 may relatively undercontribute compared to the decompressed accumulated frame of image data 150. This balances the influence of noise from the newly received frame of image data and artefacts from the accumulated frame of image data in a way which improves overall image quality in the output image 165.

Of note is that the temporal noise reducer 101 itself need not undergo any modification to benefit from the updated accumulated image data 149dc prepared at item S111. In this respect, the method 100 is suitable for use in systems in which modification of the temporal noise reducer 101 is not possible, or not desirable for some reason. For example, the method 100 can effectively be retrofit into systems using a temporal noise reducer 101 realised in an application specific circuit, without modification of the circuit.

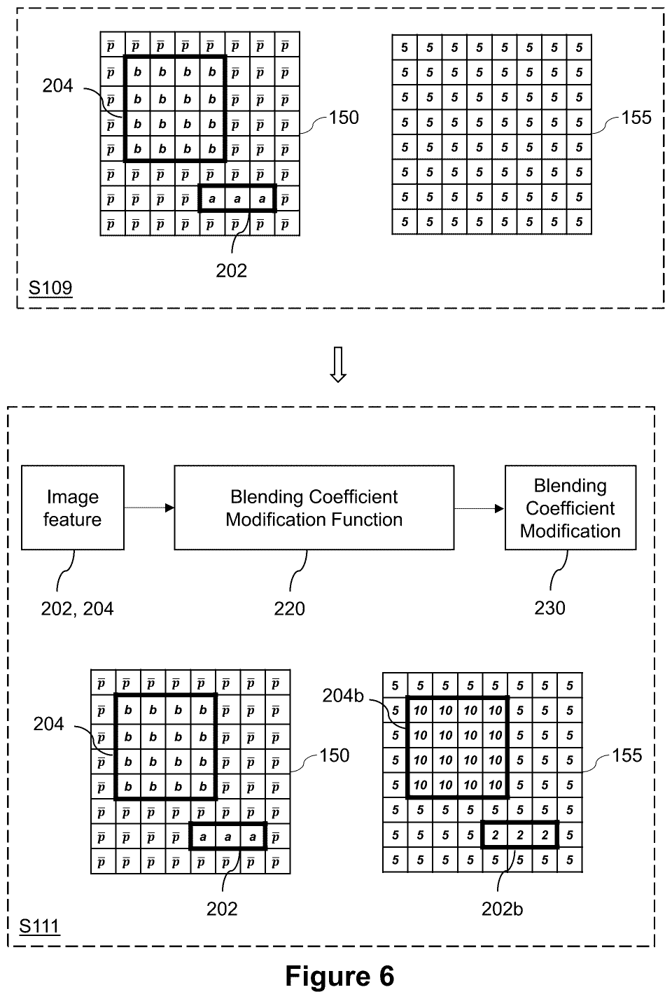

FIG. 6 illustrates schematically an example of items S109 and S111.

### Image Feature Identification

At item S109, the accumulated frame of image data 150 is analysed to identify image features. Various image processing techniques can be used to identify image features in accordance with the present disclosure. Generally, at item S109 image features are identified which are (i) themselves compression artefacts, (ii) which are more susceptible, or vulnerable, to compression artefacts, or (iii) which are less susceptible, or more resilient, to compression artefacts. In some examples all of these are identified, whereas in other examples only a subset of these are identified.

Being more susceptible to compression artefacts means that a human observer is more likely to recognise a compression artefact, or artefacts, in these areas as degradation in the perceived image quality, for example. This can mean that the presence of a compression artefact has a disproportionately strong impact in reducing the image quality of these areas. Being less susceptible to compression artefacts means that a human observer is less likely to recognise a compression artefact, or artefacts, in these areas as degradation in the perceived image quality, for example. This can mean that the presence of a compression artefact has a disproportionately weak impact in reducing the image quality of these areas.

Areas with high spatial frequency information, for example, can be more susceptible, or vulnerable, to compression artefacts. Areas with high spatial frequency information generally include parts of an image which capture finer detail including areas with sharp edges, strong periodic features, text or symbols, or features such as faces, for example.

Conversely, images with low spatial frequency information, for example, can be less susceptible, or more resilient, to compression artefacts. Areas with low spatial frequency information can correspond to areas of relatively uniform brightness, areas of low brightness overall, and generally flat areas which lack periodic structures or sharp edges, for example.

Whilst the notion of images features having high spatial frequency information and low spatial frequency information are described here, these are just examples of parts of the image which may be more or less resilient to compression and are used for explanatory purposes. The image features which are identified at item S109 need not necessarily have high spatial frequency information or low spatial frequency information.

In FIG. 6, at item S109, a subset of pixels 202 which is deemed susceptible to compression artefacts is identified in the accumulated frame of image data 150. The subset of pixels 202 are marked in FIG. 6 with “a”. In this example, this subset of pixels 202 corresponds to an area of high spatial frequency information, and is detected by applying a high-pass filter to the pixel intensity values to find details and edges. In other examples, various forms of edge detection techniques, for example, may be used in order to detect the subset of pixels 202. In yet further examples, the subset of pixels 202 may detected using, additionally or alternatively to the previously described methods, facial recognition techniques or other content-aware identification techniques. In some examples, kernel-based filtering can be used. The skilled person will appreciate that a variety of techniques can be used to identify image features in the accumulated frame of image data 150.

Instead of, or additionally to, detecting image features related to the content of the captured image, the identification of image features may include identifying characteristic compression artefacts. The identification of a characteristic compression artefact may be indicative that the area of the image at which the characteristic compression artefact is found is vulnerable to compression artefacts. For example, the detection of “mosquito noise” or motion compression block boundary artefacts may be performed. The analysis may look for particularly dark pixels, or compute quotients or differences of pixel values within a particular region, or detect particular spatial frequencies or edge orientations which might be a characteristic feature of a particular compression algorithm, for example.

In FIG. 6, at items S109 a subset of pixels 204 which is deemed resilient to compression artefacts is identified in the accumulated frame of image data 150. The subset of pixels 204 are marked in FIG. 6 with “b”. In this example, this subset of pixels 204 corresponds to an area of low spatial frequency information, and is detected by identifying a number of neighbouring pixels which are sufficiently similar to each other. The subset of pixels 204 therefore form a relatively “flat” area. Other methods can be used to identify the subset of pixels 204. For example, compression algorithms may characteristically preserve information in particular regions of images such that compression artefacts are less likely to occur in those regions. In some examples, detecting a relative lack of compression artefacts in a region of the image can indicate that the region is less susceptible to compression artefacts, even without conducting an analysis of underlying properties of the image region. More generally, methods used to detect high frequency details, for example, can also indicate a relatively “flat” area by providing a relatively weak response, and hence similar methods can be employed in identifying each subset of pixels 202, 204 by looking for different characteristics in the response, for example.

In some examples of detecting the subsets of pixels 202, 204, a calibration process may be performed to characterise an underlying level of noise present in the image, and the image feature identification method adjusted to take into account this calibration. This can avoid, or reduce the likelihood of, erroneously detecting noise as a high spatial frequency detail, for example.

Whilst subsets of pixels 202, 204 are identified in identifying the image features, the image feature recognition may consider the properties of neighbouring pixels not included in these subsets, for example, or global information related to the image frame, in order to establish that the subset of pixels 202 corresponds to an image feature which is vulnerable to compression artefacts, or that the subset of pixels 204 corresponds to an image feature which is resilient to compression artefacts.

### Modification of Blending Coefficients

Having identified image features 202 which are susceptible to compression artefacts and/or image features 204 which are resilient to compression artefacts, such as by detecting image features having high and low spatial frequency information, at item S109, at item S111 the blending coefficients are modified. In this example, the blending coefficients 155 are uniformly valued “5” across the accumulated frame of image data 150 prior to item S111.

The pixel locations corresponding to image features 204, 202 are passed to a blending coefficient modification function 220 to determine a blending coefficient modification 230 to be applied to the blending coefficients corresponding to those pixel locations. The blending coefficient modification 230, herein also referred to as a modification value 230, is applied to the respective blending coefficients 155.

In the example of FIG. 6, for the image feature corresponding to subset of pixels 202 which corresponds to an area more susceptible to compression artefacts, in this example being an area of high spatial frequency information, the blending coefficient modification function 220 outputs a modification value 230 of “−3”. The corresponding blending coefficients 202b are updated from “5” to “2” based on the modification value 230. For the subset of pixels 204 which correspond to an area more resilient to compression artefacts, in this example being an area of low spatial frequency information, the blending coefficient modification function 220 outputs a modification value 230 of “+5” and so corresponding blending coefficients 202b are updated from “5” to “10” based on the modification value 230.

Accordingly, when the temporal noise reducer 101 subsequently uses the updated blending coefficients 155 to combine the newly received frame of image data 160 with the accumulated frame of image data 150, the relative weight of the accumulated frame of image data 150 in forming the subset of pixels 202 of the output image 165 is decreased compared with the case where the blending coefficient has its original value of “5”. This is because the temporal noise reducer 101 blends according to the updated blending coefficient value in a 1:2 ratio (new frame:accumulated frames), rather than in a 1:5 ratio. Similarly, the temporal noise reducer 101 blends according to the updated blending coefficient value 204b in a 1:10 ratio (new frame:accumulated frames) in forming the subset of pixels 204 of the output image 165. This decreases the contribution of the newly received frame of image data 160 relative to the accumulated frame of image data 150 compared with the case where the blending coefficient has its original value of “5”. By reducing the contribution of the newer component to the output image relative to the contribution of the older, accumulated image data, any noise present in the image may appear static between consecutive frames, effectively temporally stabilising the noise, which can render the noise less perceptible to an observer.

Various blending coefficient modification functions 220 are envisaged, and the skilled person will appreciate that the following are provided as non-limiting examples.

In examples, the degree of modification of the blending coefficients may depend on the identified image feature associated with the blending coefficient. For instance, the flatter, or lower spatial frequency information content of, a feature, the larger modification may be made to the blending coefficients associated with the pixels associated with the feature. The blending coefficients may be increased such that the accumulated image frame is weighted more highly during combination with the newly received image frame. Similarly, the higher the spatial frequency information content of a feature, the larger the modification to the associated blending coefficients may be made to decrease the blending coefficients such that the newly received image frame is weighted more highly during combination with the accumulated image frame. More generally, a measured value of the image feature can be used to determine the blending coefficient modification using the blending coefficient modification function.

The blending coefficient modification function 220 may be based on achieving a desired blending ratio of new frame data 160 with accumulated frame data 150. For instance, in examples the temporal noise reducer 101 will, when generating the output image 165, mix an amount α of new frame data 160 with an amount α−1 of the decompressed data pixel data, where 0≤α≤1. The temporal noise reducer will determine a using a formula such as:

$$α = \frac{1}{N + 1}$$

where N is the blending coefficient. An inverse formula such as:

$$N = \frac{1 - α}{α}$$

can be used to obtain the blending coefficient N required for a desired value for α (i.e. a desired mixing ratio, or mixing “strength”, between the new frame data 160 and the accumulated frame data 150). The blending coefficient modification function 220 can be arranged to modify the blending coefficients 155 to achieve this value for α, for example. The desired value for α may be based on particular value which has been demonstrated to produce a higher quality of image output, for example.

In some examples, the blending coefficient modification function may be a threshold function. The threshold can place a bound, or upper and lower bounds, on the value which the blending coefficient can take. For example, it could ensure that the blending coefficient does not fall beneath 2, or rise above 30, for example. The use of a threshold may be useful because, for example, for blending coefficients associated with pixel values containing high spatial frequency information, it may be desirable that the contribution of the accumulated pixel values does not go above, T−1/T, where T is a threshold value. However, if the current blending value is below T, it is not desired to increase the contribution of the accumulate pixel values. Similarly, for blending coefficients associated with pixel values containing low spatial frequency information, it may be desirable that the contribution of the accumulated pixel values does not go below, T−1/T, where T is a threshold value. However, if the current blending value is already above T, it is not desired to decrease the contribution of the accumulate pixel values.

In some examples, the threshold value T may vary in dependence upon the output of a high-pass or low-pass filter applied to the pixel values. Accordingly, the threshold T may decrease with increasing output of a high-pass filter (or decreasing output from a low-pass filter) for blending coefficients associated with high spatial frequency information. Alternatively or in addition, the threshold T may increase with increasing output from a low-pass filter (or decreasing output from a high-pass filter) for blending coefficients associated with low frequency spatial information.

In other examples, the blending coefficient modification function may be substantially non-linear such that the blending coefficients are non-linearly varied. For example, the blending coefficient may be non-linearly varied in dependence upon the frequency of the spatial information associated with the pixel values. For example, a sigmoid function or a polynomial function may be used to determine the resulting modification to the blending coefficients 155.

The blending coefficient modification function 220 could effectively implement a look-up table, for example, defining a limited range of modification approaches. For example, the blending coefficient modification function 220 could define that blending coefficients 155 associated with areas 202 susceptible to compression artefacts, such as high spatial frequency image features, are always modified in one way, such as setting the blending coefficient to a fixed value, or applying a fixed modification value, whereas blending coefficients 155 associated with areas 204 resistive to compression artefacts, such as low spatial frequency image features, are always modified in a different way.

The blending coefficient modification function 220 may be selected dependent on the image feature 202, 204 which has been identified, for example. For example, a first blending coefficient modification function 220 may be used when edge features are detected, whereas a second blending coefficient modification function 220 may be used where faces are detected. The modification to the blending coefficients may selected based on a perceived vulnerability or resilience to compression. For example, where a face is detected, blending coefficients may be modified differently non-face features which otherwise are associated with similar levels of high spatial frequency information. Similarly, where compression artefacts are detected as image features, different sorts of compression artefacts may result in different modifications to the blending coefficient.

The example blending coefficient modification functions 220 described in view of FIG. 6 may apply a uniform modification value 230 to the blending coefficients 155 associated with the image features 202, 204. In other examples, for a given image feature, the blending coefficients may be modified non-uniformly across the pixels associated with the image feature. For example, some pixels associated with the image feature may receive a first modification to their associated blending coefficients whilst other pixels associated with the image feature receive a second modification to their associated blending coefficients, different to the first modification. The modification to the blending coefficient may depend upon the colour, size, or the relative brightness of an image feature, for example.

### Image Processing Apparatus

FIGS. 1 and 5 illustrate examples of apparatus, or devices, for processing image data and for performing the method 100. In some examples, devices for performing the method 100 comprises at least one storage and at least one processor. The processor may be a central processing unit or other type of processing unit, and the storage may be a storage device such as an SSD, a hard drive, or an SRAM or DRAM buffer, for example. Data can be communicated between components, such as the at least one storage and at least one processor, by data buses, network communications, or the like. The devices 1000, 1001 may in some examples be a mobile device such as a mobile phone or PDS. In other examples, the device may be a computer such as a laptop or desktop PC. In other examples, the device may be a server or cloud service. These examples are not exhaustive, and the device may take other forms not mentioned.

In some examples, one or more steps of the method 100 can be performed in hardware and performed using fixed function circuitry. Fixed function circuitry may comprise dedicated hardware circuitry that is configured specifically to perform a fixed function, and that is not reconfigurable to perform a different function. In this way, the fixed function circuitry can be considered distinct form a programmable circuit that is configured to receive and decode instructions defined, for example, in a software program. For example, the fixed function circuitry may not be reconfigurable to perform another function. Fixed function circuitry may comprise at least one electronic circuit for performing an operation. Any fixed function circuitry may comprise application-specific integrated circuitry. The application-specific integrated circuitry may comprise one or more integrated circuits and may be designed using a hardware description language such as Verilog and implemented as part of the fabrication of an integrated circuit. The application-specific integrated circuitry may comprise a gate-array or a full custom design. The application specific integrated circuit may include any number of processors, microprocessor, and/or storage blocks, including RAM, ROM, EEPROM, or flash storage.

For example, the temporal noise reducer 101 may be realised in one or more hardware components. The compressor/decompressor 105 may be realised in one or more hardware components. Processing blocks 107a, 107b may be realised in one or more hardware components.

The method 100 may be performed by an image signal processor realised in one or more hardware components and configured to process image data according to the method. The method 100 may be performed in a system comprising a mixture of hardware components configured to perform steps of the method and non-specific computing devices running software for performing other steps of the method, for example. The method 100 may be implemented as a computer program. The computer program may be stored on a computer-readable storage medium and read by one or more information processing apparatus, such as the devices described above, for the purposes of performing such a method.

The above embodiments are to be understood as illustrative examples of the invention. Further embodiments of the invention are envisaged:

In examples, in conjunction with or additionally to the analysis of the image data for identification of image features and subsequent modification of blending coefficients, the blending coefficients themselves may be analysed to determine the image feature identification, for example. For instance, in areas with a lower blending coefficients, higher levels of noise can be expected. As a result, the use of a high-pass filter may be set with a different threshold to compensate for the higher “base” level of noise to avoid false detection of relevant image features, for example.

In examples, in the previously described examples, each pixel has a corresponding blending coefficient in a 1-to-1 ratio. In other examples, a blending coefficient may refer to regions of pixels, such as N-by-N regions, or N-by-M regions, or regions of arbitrary shapes. Some blending coefficients may apply to single pixels whilst other blending coefficients refer to regions of pixels.

The above methods may be performed on a pixel-region by pixel region basis. For example, a high or low pass filter or other feature detection method may be applied to a block of pixels, such as 8 by 8 or 16 by 16 pixels in order to determine the nature of the spatial information surrounding a pixel value. Similarly, the compression/decompression algorithm may be a block-based compression algorithm. The high or low pass filter or other feature detection algorithm may be applied on the same or similar sized blocks to the compression algorithm.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of processing image data comprising:
receiving decompressed accumulated image data that has been subjected to a lossy compression algorithm, the accumulated image data including:
an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and
accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data;
updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and
sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

2. The method of claim 1, wherein the at least one blending coefficient is modified such that in generating the output image data by the temporal noise reducer, a contribution of the new frame of image data is increased.

3. The method of claim 2, wherein the modification of the blending coefficient is performed by comparing the blending coefficient to a threshold value.

4. The method of claim 2 wherein the image feature corresponds to an area of the accumulated frame of image data having higher spatial frequency information than another part of the accumulated frame of image data.

5. The method of claim 4, wherein the image feature is at least partially identified by performing a high-pass filtering on at least a portion of the accumulated frame of image data.

6. The method of claim 2, wherein the image feature is at least partially identified by performing edge detection on at least a portion of the accumulated frame of image data.

7. The method of claim 1, wherein the image feature is at least partially identified by performing facial recognition on at least a portion of the accumulated frame of image data.

8. The method of claim 1, wherein the image feature is at least partially identified by detecting a characteristic feature of the lossy compression process.

9. The method of claim 1, wherein the blending coefficient is modified such that in generating the output image data by the temporal noise reducer, a contribution of the new frame of image data is decreased.

10. The method of claim 9, wherein the image feature corresponds to an area of lower spatial frequency information than another part of the accumulated frame of image data.

11. The method of claim 1, wherein the image feature is at least partially identified by identifying a luminance of the accumulated image data.

12. The method of claim 1 wherein each blending coefficient of the accumulated image metadata is a number of frames of previous image data used to generate the pixel intensity value at the corresponding pixel location, and each pixel intensity value of the accumulated frame of image data is an arithmetic mean of the corresponding pixel intensity values of the number of frames of previous image data indicated by the blending coefficient.

13. The method of claim 1, further comprising generating the output image data by the temporal noise reducer.

14. The method of claim 13, further comprising updating the accumulated image data based on the output image data.

15. The method of claim 1, further comprising receiving the accumulated image data from the temporal noise reducer.

16. The method of claim 15, further comprising sending the accumulated image data to a compressor for compressing by a lossy compression process.

17. The method of claim 16, further comprising storing the compressed accumulated image data.

18. Image processing apparatus comprising
at least one processor; and
at least one storage;
the apparatus configured to perform a method comprising at least:
receiving decompressed accumulated image data that has been subjected to a lossy compression algorithm, the accumulated image data including:
an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and
accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data;
updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and
sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.

19. A non-transitory computer-readable storage medium comprising computer-executable instructions which when executed by a processor cause operation of an image processing system to perform a method comprising at least:
receiving decompressed accumulated image data that has been subjected to a lossy compression algorithm, the accumulated image data including:
an accumulated frame of image data comprising a plurality of pixel intensity values, each pixel intensity value of the accumulated frame of image data representing a respective pixel location and some or all of the pixel intensity values representing an average of pixel intensity values of corresponding pixel locations from two or more of the plurality of frames of previous image data, and
accumulated image metadata comprising a plurality of blending coefficients, each blending coefficient associated with one or more respective pixel locations of the accumulated frame of image data and corresponding to a number of frames of previous image data used to generate the pixel intensity value at the respective pixel location of the accumulated frame of image data;
updating the blending coefficients of the decompressed accumulated image data by: identifying an image feature associated with at least one pixel location of the decompressed accumulated frame of image data, and modifying at least one blending coefficient of the accumulated image metadata corresponding to the at least one pixel location based on the image feature; and
sending the updated blending coefficients and the decompressed accumulated frame of image data to a temporal noise reducer, the temporal noise reducer configured to generate output image data by combining a new frame of image data with the decompressed accumulated frame of image data based on the updated blending coefficients of the decompressed accumulated image metadata, the updated blending coefficients being usable to determine the relative contributions of the pixel intensity values of the new frame of image data and the pixel intensity values of the decompressed accumulated frame of image data to the pixel intensity values of the output image data at each pixel location.
